(19) United States
(12) Patent Application Publication
(10) Pub. No.: US 2006/0139336 A1
(43) Pub. Date: Jun. 29, 2006

(54) Method to validate the identity of a user of a mobile computer and mobile computer

(75) Inventors: Mark Mattingley-Scott, Heidelberg (DE); Michael Pyschny, Gerlingen (DE)

Correspondence Address: IBM CORPORATION, IPLAW IQ0A/40-3, 1701 NORTH STREET, ENDICOTT, NY, 13760, US

(73) Assignee: International Business machines Corporation, Armonk, NY (US)

(21) Appl. No.: 11/280,112

(22) Filed: Nov. 15, 2005

(30) Foreign Application Priority Data
Dec. 23, 2004 (EP) 04106945.1

(51) Int. Cl. G09G 5/00

(52) U.S. Cl. 345/173

(57) ABSTRACT

The present invention provides a method to validate the identity of a user of a mobile computer, especially a laptop computer or a notebook computer, which comprises an integral pointing device. The method is characterized in that the integral pointing device of the mobile computer is used as signature input device to identify a signature of the user. The present invention further provides a new mobile computer, especially a laptop computer or a notebook computer, which comprises an integral pointing device being able to record the signature of a user sufficiently accurate to allow signature recognition and thus user identification. Preferably the integral pointing device is able to detect multiple pressure levels for dynamic signature recognition.

### FIELD OF THE INVENTION

The present invention relates to a method to validate the identity of a user of a mobile computer, including a laptop computer or a notebook computer, comprising an integral pointing device, e.g. a touchpad, a trackpad or a scratchpad.

### BACKGROUND OF THE PRESENT INVENTION

The invention is intended to enable biometrically verified identification of a user at the place where the user works at the computer. Biometrics is a term which can refer to several types of attributes. Broadly we can classify these into two types—those which depend on some physical attributes so called physiological biometrics, and those which depend on some learned behavior so called behavioral biometrics.

Validation of the identity of a user of a mobile computer is achievable through the use of knowledge of a password or a personal identification number (PIN). Further there exists external pad devices with integrated personal signature capabilities.

### OBJECT AND SUMMARY OF THE INVENTION

An object of the present invention is to provide a secure method to validate the identity of a user of a mobile computer, including a laptop computer or a notebook computer, which comprises an integral pointing device, e.g. a touchpad, a trackpad or a scratchpad. A further object of the present invention is to provide a mobile computer, including a laptop computer or a notebook computer, which comprises an integral pointing device, e.g. a touchpad, a trackpad or a scratchpad, and which is capable to validate the identity of a user in an easy and secure way.

According to one aspect of the present invention there is provided a method to validate the identity of a user of a mobile computer comprising the steps of providing the mobile computer having an integral pointing device, sensitive to a position of the manually driven input means, the device able to track the position of the manually driven input means, the user providing a signature by moving the manually driven input means on the integral pointing device, the integral pointing device outputting digital data in response to the signature, and the mobile computer evaluating the digital data for validating the identity of the user.

According to another aspect of the present invention their is provided a mobile computer comprising an integral pointing device being sensitive to a position of a manually driven input means and being able to track the position of the manually driven input means on the integral pointing device, characterized in that the integral pointing device outputs digital data in response to a signature of the user responsive to movement of the manually driven input means on the integral pointing device, and in that the mobile computer includes evaluation means for evaluating the digital data for validating the identity of the user.

According to yet another aspect of the present invention there is provided a computer program product stored in the internal memory of a digital computer, containing parts of software code to execute a method to validate the identity of a user of a mobile computer comprising the steps of providing the mobile computer having an integral pointing device, sensitive to a position of a manually driven input means, the device able to track the position of the manually driven input means, the user providing a signature by moving the manually driven input means on the integral pointing device, the integral pointing device outputting digital data in response to the signature, and the mobile computer evaluating the digital data for validating the identity of the user.

The above objects, advantages, and features of the present invention will become more readily apparent from the following detailed description of the presently preferred embodiments as illustrated in the accompanying drawings.

### BRIEF DESCRIPTION OF THE DRAWINGS

FIG. 1 shows an embodiment of a mobile computer according to the invention, and

FIG. 2 shows a schematic overview of the mobile computer including the integral pointing device.

### DETAILED DESCRIPTION OF THE INVENTION

The present invention provides a method to validate the identity of a user of a mobile computer, especially a laptop computer or a notebook computer, which comprises an integral pointing device, e.g. a touchpad, a trackpad or a scratchpad.

The integral pointing device of the mobile computer is used as signature input device for the purpose of identification of the user. Signature recognition is used to validate the identity of the user of the mobile computer. Provided that the integral pointing device of known mobile computers is not accurate enough to correctly identify a signature, the known integral pointing device is replaced by a more sensitive integral pointing device which has the ability to correctly detect and recognize signatures in handwriting.

Using the integral pointing device is advantageous over the use of external signature recording devices since the data integrity is guaranteed due to fully internal data connections between the integral pointing device and the evaluation means for evaluating the digital data for validating the identity of said user.

For the known integral pointing device, e.g. the touchpad, a finger of the user is used as manually driven input means. For providing the signature it is preferred to use a writing instrument such as a pen, a stylus, a pin or the like.

Either the operating system or an application software can control whether the integral pointing device is used as a pointing device providing position data of the manually driven input means or for signature recording providing digital data according to the present invention. The signature evaluation can be used in addition or as an alternative to the request for inputting a password when starting the operation system of the mobile computer or when requesting access to a data network during log-on procedures.

Furthermore it is possible to use the integral pointing device on the basic input output system (BIOS) level when booting the mobile computer. The digital data outputted by the integral pointing device can be inputted to a trusted computing chip of the mobile computer which serves for validating the identity of the user, preferably by comparing the digital data with stored reference data. Evaluation and/or validation can be implemented in the integral pointing device which may have an interface to the BIOS system of the mobile computer.

Furthermore the digital data outputted by the integral pointing device, either in original form or preprocessed by the mobile computer, can be transmitted over a data network. A digital signature of the mobile computer can be added in order to allow the recipient of the digital data to check the received data for authenticity and integrity.

A preferred embodiment of the method is characterized in that the integral pointing device is used as a position and pressure sensor means for a writing instrument. The position and pressure sensor means is preferably used in combination with corresponding signature recognition software. An algorithm is used to extract characteristic measurements of the signing action. The identity of the person wishing to use the mobile computer can be validated against reference data, e.g. a signature template for an authorized user, which are stored either on the mobile computer itself or on a smart card or on a device connected to the mobile computer, or in a data base which is accessible from the mobile computer.

The reference data may be unalterable by the user but under control of an administrator. The reference data can be generated externally of said computer, e.g. on a reference input means commonly used for a number of mobile computers, to enable full control by the administrator. Furthermore it is possible to generate the reference data locally on the integral pointing device to ease adaptation to variations and/or for providing the same hardware situation during generating the reference data and during providing signature for user identification.

A further preferred embodiment of the method is characterized in that the integral pointing device is used to detect the angle of the writing instrument in relation to the integral pointing device. Preferably the writing instrument is a pen.

A further preferred embodiment of the method is characterized in that the integral pointing device is used to detect the speed and/or acceleration of the writing instrument in relation to the integral pointing device.

The present invention further provides a new mobile computer, especially a laptop or a notebook, which comprises an integral pointing device according to the present invention.

Preferably the new mobile computer is characterized in that the integral pointing device is able to detect multiple pressure levels, which are necessary for dynamic signature recognition. The main idea of the present invention is to combine on the same integral pointing device, both signature recognition and usual integral pointing device functions, e.g. cursor movement.

A preferred embodiment of the mobile computer is characterized in that a common capacitive single-bit sensor of the integral pointing device is replaced with a multi-bit sensor in order to be able to capture the dynamics of signatures.

The present invention relates further to a computer program product stored in the internal memory of a digital computer, containing parts of software code to execute the above described method.

The reliability and usability of biometrics usually relate to two measures: the ease with which a template of the biometric is enrolled, and the reliability of a positive match with a valid identity and a positive mismatch with an invalid identity. It is also necessary to distinguish between matching against a known population (verifying the identity) and against an unknown population (establishing the identity).

The types of biometrics may be summarized as follows. Physiological biometrics comprise fingerprint, hand geometry, iris pattern, retina pattern, face geometry etc. Behavioral biometrics comprise voice pattern, gait, handwriting/signing etc.

It is the process of handwriting, not the visual representation of a completed signature which allows a highly reliable verification of identity. Although visual representation is sufficient in most legally relevant scenarios (signing contracts basically), to obtain the same level of burden of proof electronically requires capturing the dynamics of the signature: position, pressure and angle of pen; all of them in real-time.

In terms of convenience of one in particular business scenarios it is also important to understand how biometrics capture systems are integrated into business processes and what means of validating identity are already in use. All commercial situations pre-suppose the use of signatures written on paper with some kind of pen. At least according to laws of many countries this is a clear evidence of an act of will, something which is key in business processes.

The invention allows for both the capture/enrolment in a secure way, and the validation of identity at any appropriate situation in the use of the computer, or allows for the explicit capture of an act of will if necessary. This is enabled by a form factor which allows retrofitting into an existing computer.

Behavioral biometrics are stronger evidence of an act of will because they cannot be stolen or reconstructed but only be reproduced wilfully by the valid individual.

In the present invention, the integral pointing device of a laptop computer is used as signature input device to identify a signature of the user. The integral pointing device is used as a position and pressure sensor means for a pencil. The position and pressure sensor means is used in combination with corresponding signature recognition software. An algorithm is used to extract characteristic measurements of the signing action. The integral pointing device is used to detect the angle, the speed and/or acceleration of the writing instrument in relation to the integral pointing device. The integral pointing device is able to detect multiple pressure levels, which are necessary for dynamic signature recognition. The main idea of the present invention is to combine on the same integral pointing device, both signature recognition and usual integral pointing device functions, e.g. cursor movement. A common capacitive single-bit sensor of the integral pointing device is replaced with a multi-bit sensor in order to be able to capture the dynamics of signatures.

An algorithm is used to extract characteristic measurements of the signing action. The identity of the person wishing to use the mobile computer can be validated against a signature template for an authorized user which can be stored either on a smart card or on a device connected to the mobile computer, or in a data base which is accessible from the mobile computer.

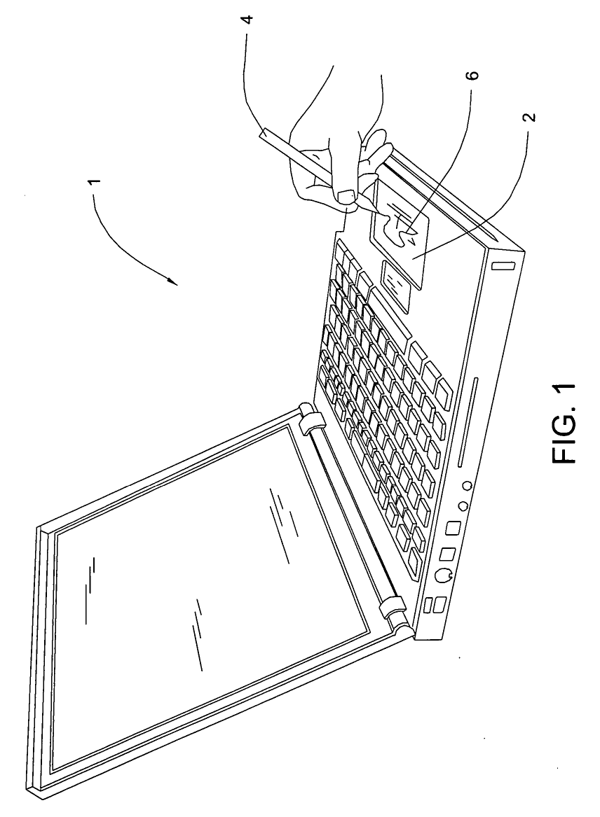

FIG. 1 shows an embodiment of a mobile computer 1 according to the present invention. Mobile computer 1 comprises an integral pointing device 2 which is a so called touchpad. Integral pointing device 2 is sensitive to a position of a manually driven input means 4, for example, a pen. Integral pointing device 2 tracks the position of manually driven input means 4 on the integral pointing device 2.

As shown, a signature of a user is provided by moving manually driven input means 4 on integral pointing device 2. In response, integral pointing device 2 outputs digital data on a wired connection line (not shown) not accessible from the external area of mobile computer 1. Evaluation means integral with mobile computer 1 evaluates the digital data for validating the identity of the user.

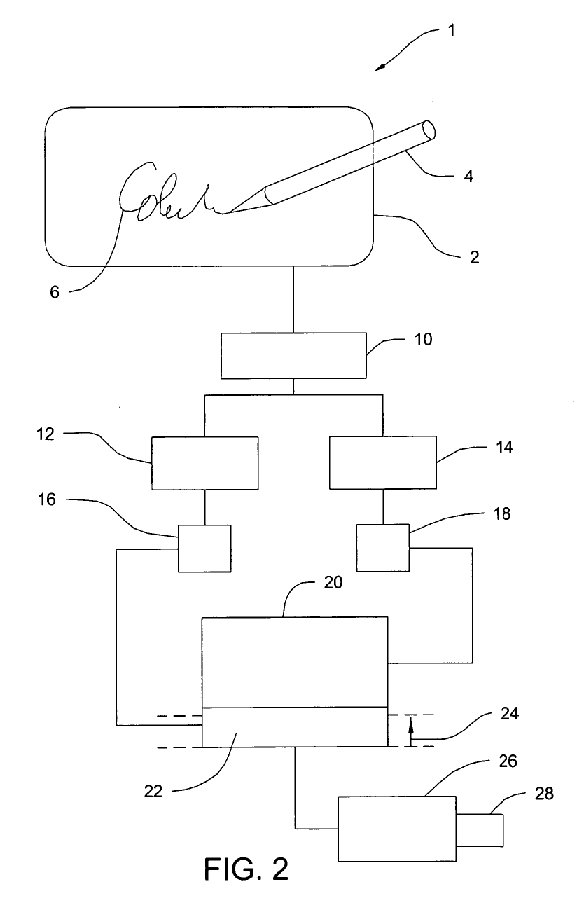

FIG. 2 shows a schematic overview of mobile computer 1 including integral pointing device 2 with input means 4 while the user's signature 6 is provided. Integral pointing device 2 converts signature 6 into digital data which are outputted either to a pad emulator 12 or to a mouse emulator 14 under control of a control unit 10.

Mouse emulator 14 is connected logically or physically to a mouse driver 18 which itself being under control or part of the operating system 20 of mobile computer 1. In this mode, integral pointing device 2 is used like a computer mouse e.g. for positioning a pointer on the screen of mobile computer 1 using a finger of the user. In particular in this mode it is not necessary to use any particular input means 4.

Pad emulator 12 is connected logically or physically to a pad driver 16 itself being under control or part of security or utility functions which are implemented in operating system 20 of mobile computer 1 or in a particular security system 22 which is located within the BIOS level 24 of the mobile computer 1. In this mode it is advantageous to use input means 4 which preferably has a rounded tip to slide smoothly on the surface of integral pointing device 2.

The digital data outputted by integral pointing device 2 may be compared with reference data internally stored in mobile computer 1, the reference data in particular are already accessible for security system 22 on BIOS level 24. Furthermore it is possible, in addition to or as an alternative, to provide the reference data form external of mobile computer 1, e.g. via a data input unit 26 connected to security system 22. Data input unit 26 can receive data from a data storage media 28. In this embodiment data input unit 26 is a memory card reader, e.g. a smart card reader, that can read reference data from a memory card or smart card as data storage media 28.

Integral pointing device 2 has pressure sensitivity with 8 bit resolution corresponding to 256 levels of pressure detectable as change in resistivity of the sensor element of integral pointing device 2. During registration or enrollment, e.g. during installation of operating system 20 on mobile computer 1, or under control of an administrator or supervisor within appropriate security policy framework, multiple signatures 6 are sampled for quality check and for generating the reference data. Such reference data can be stored e.g. either locally on a hard disk, locally in the BIOS permanent memory or in combination with other security features on mobile computer 1 or on a separate token as a smartcard.

What has been shown and described are at present considered the preferred embodiments of this invention, it will be obvious to those skilled the art that various changes and modifications can be made therein without departing from the scope of the invention as defined by the appended claims.

What is claimed is:

1. A method to validate the identity of a user of a mobile computer comprising the steps of:
providing said mobile computer having an integral pointing device, sensitive to a position of a manually driven input means, said device able to track the position of said manually driven input means, said user providing a signature by moving said manually driven input means on said integral pointing device, said integral pointing device outputting digital data in response to said signature; and
said mobile computer evaluating said digital data for validating the identity of said user.

2. The method according to claim 1, wherein said integral pointing device further includes sensitivity to pressure applied by said manually driven input means on said integral pointing device, and outputting said digital data depends, at least in the section of said signature, on the position of said manually driven input means as well as on pressure applied by said manually driven input means on said integral pointing device.

3. The method according to claim 2, wherein said integral pointing device further includes sensitivity to direction of pressure applied by said manually driven input means on said integral pointing device in order to detect the angle of said manually driven input means in relation to said integral pointing device.

4. The method according to claim 1 further including the step of detecting the speed and/or acceleration of said manually driven input means in relation to said integral pointing device during said signature.

5. The method according to claim 1 further including the step of storing reference data in said mobile computer, said reference data being characteristic for said signature of said user, and outputting said digital data by said integral pointing device in response to said signature and comparing said digital data with said reference data for validating the identity of said user.

6. The method according to claim 5, wherein said storing step includes said reference data generated externally of said mobile computer, in particular unalterably for said user.

7. The method according to claim 5, further including the step of generating said reference data using said integral pointing device of said mobile computer.

8. A mobile computer, comprising an integral pointing device being sensitive to a position of a manually driven input means and being able to track the position of said manually driven input means on said integral pointing device, characterized in that said integral pointing device outputs digital data in response to a signature of said user responsive to movement of said manually driven input means on said integral pointing device, and in that said mobile computer includes evaluation means for evaluating said digital data for validating the identity of said user.

9. The mobile computer according to claim 8, wherein said integral pointing device further includes being sensitive to pressure applied by said manually driven input means on said integral pointing device with multi-bit resolution on applied pressure, and in that said output of said digital data depends, at least in the section of said signature, on the position of said manually driven input means as well as on pressure applied by said manually driven input means on said integral pointing device.

10. The mobile computer according to claim 9, wherein said integral pointing device further includes sensitivity to direction of pressure applied by said manually driven input means on said integral pointing device in order to detect the angle of said manually driven input means in relation to said integral pointing device.

11. The mobile computer according to claim 8 wherein said integral pointing device further includes means to detect the speed and/or acceleration of said manually driven input means in relation to said integral pointing device during said signature.

12. The mobile computer according to claim 8, wherein reference data are stored in said mobile computer, said reference data being characteristic for said signature of said user, and in that said digital data output by said integral pointing device responsive to said signature can be compared with said reference data for validating the identity of said user.

13. The mobile computer according to claim 12, wherein said reference data are generated externally of said mobile computer and are stored in said mobile computer, in particular unalterably for said user.

14. The mobile computer according to claim 12, wherein said reference data are generated using said integral pointing device.

15. A computer program product stored in the internal memory of a digital computer, containing parts of software code to execute a method to validate the identity of a user of a mobile computer comprising the steps of: providing said mobile computer having an integral pointing device, sensitive to a position of a manually driven input means, said device able to track the position of said manually driven input means, said user providing a signature by moving said manually driven input means on said integral pointing device, said integral pointing device outputting digital data in response to said signature, and said mobile computer evaluating said digital data for validating the identity of said user.

16. The computer program product of claim 15, wherein said integral pointing device further includes sensitivity to pressure applied by said manually driven input means on said integral pointing device, and outputting said digital data depends, at least in the section of said signature, on the position of said manually driven input means as well as on pressure applied by said manually driven input means on said integral pointing device.

17. The computer program product of claim 16, wherein said integral pointing device further includes sensitivity to direction of pressure applied by said manually driven input means on said integral pointing device in order to detect the angle of said manually driven input means in relation to said integral pointing device.

18. The computer program product of claim 15, further including the step of detecting the speed and/or acceleration of said manually driven input means in relation to said integral pointing device during said signature.

19. The computer program product of claim 15, further including the step of storing reference data in said mobile computer, said reference data being characteristic for said signature of said user, and outputting said digital data by said integral pointing device in response to said signature and comparing said digital data with said reference data for validating the identity of said user.

20. The computer program product of claim 19, wherein said storing step includes said reference data generated externally of said mobile computer, in particular unalterably for said user.

21. The computer program product of claim 19, further including the step of generating said reference data using said integral pointing device of said mobile computer.
